(19) United States
(12) Patent Application Publication
(10) Pub. No.: US 2005/0144988 A1
(43) Pub. Date: Jul. 7, 2005

(54) Apparatus for heating optical fiber preform and method for manufacturing optical fiber preform

(76) Inventors: Young-Sik Yoon, Chilgok-gun (KR); Mun-Hyun Do, Chilgok-gun (KR)

Correspondence Address: CHA & REITER, LLC, 210 ROUTE 4 EAST STE 103, PARAMUS, NJ, 07652, US

(21) Appl. No.: 10/919,730

(22) Filed: Aug. 17, 2004

(30) Foreign Application Priority Data
Jan. 6, 2004 (KR) 2004-773

(51) Int. Cl. C03B 37/018

(52) U.S. Cl. 65/507; 65/422; 65/426; 65/529

(57) ABSTRACT

An apparatus for heating an optical fiber preform and a method for manufacturing the optical fiber preform are disclosed, in which the optical fiber preform aligned in a vertical direction is heated by stacked heating sources. The apparatus for heating the optical fiber preform includes a muffler accommodating the optical fiber preform therein, and at least two heating sources aligned lengthwise along the optical fiber preform.

### CLAIM OF PRIORITY

This application claims priority to an application entitled “Apparatus for Heating Optical Fiber Preform and Method for Manufacturing Optical Fiber Preform,” filed in the Korean Intellectual Property Office on Jan. 6, 2004 and assigned Ser. No. 2004-773, the contents of which are hereby incorporated by reference.

### BACKGROUND OF THE INVENTION

1. Field of the invention

The present invention relates to an apparatus for heating an optical fiber preform and a method for manufacturing the same, and more particularly to an apparatus for heating an optical fiber preform, which is aligned in a vertical direction by stacked heating sources.

2. Description of the Related Art

Generally, a VAD method (vapor-phase axial deposition method) is known in the art as a method for manufacturing masses of glass preforms used for fabricating optical fibers. According to the VAD method, a cylindrical optical fiber preform (soot preform) is formed by depositing glass particles created from an oxyhydrogen flame on a rotatable initiation member, such as a glass plate or a glass rod, and sintering an optical fiber preform, so that a transparent optical fiber glass preform can be formed. In addition, it is necessary that the optical fiber preform is heated with a temperature above 1,500° C. under an inert gas atmosphere, such as He and Cl₂ gases, by sintering the optical fiber preform.

A heating apparatus typically includes a carbon susceptor used for sintering the optical fiber preform. Moisture or transition metal elements, such as Cu or Fe, must be prevented from penetrating the optical fiber glass preform while sintering the optical fiber preform using the heating apparatus. If more than 1 ppb of the transition metal element is mixed with the optical fiber glass preform, a transmission loss wavelength characteristic of the manufactured optical fiber glass preform is significantly deteriorated throughout all of the wavelengths. Further, if more than 0.1 ppm of moisture is mixed with the optical fiber glass preform, various characteristics of the manufactured optical fiber glass preform are damaged over a wide range of wavelengths. To address this, a dehydration process is carried out with respect to the optical fiber preform before the optical fiber preform is changed into a transparent state, or when the optical fiber preform is changed into the transparent state. A method for heating the optical fiber preform at high temperature under the inert gas atmosphere including Cl₂-based gas and F-based gas is known as a dehydrating method. If the F-based gas is used, F is added to the optical fiber preform while the optical fiber preform is being subject to the dehydration process.

For this reason, a zone-sintering heat treatment process is mainly used for heat-treating the optical fiber preform used for manufacturing the optical fiber. The zone-sintering heat treatment process has an advantage as compared with a full-sintering heat treatment process in that bubbles can be easily removed so that densification glass can be easily manufactured, and thus high-purity glass can be manufactured using the above-mentioned gases. In addition, equipment for the zone-sintering heat treatment process may be simpler than that of the full-sintering heat treatment process. However, the height of equipment for performing the zone-sintering heat treatment process is higher than the full-sintering heat treatment process, and the manufacturing cost for such equipment is very expensive.

Hereinafter, the structure of a heating apparatus 10 performing the heat treatment process for manufacturing an optical fiber preform will be explained. As shown in FIG. 1, an optical fiber preform 12 is inputted into a long muffler 11 having a length of about 3˜4 m in such a manner that the optical fiber preform 12 can be heat-treated while moving up and down in the long muffler 11. A supporting rod 14 is connected to an upper portion of the optical fiber preform 12 for moving the optical fiber preform 12 up and down in the muffler 11. A heating source 13 is fixedly provided in a circumferential direction of the muffler 11. A gas injection inlet 15 is formed at a lower portion of the muffler 11, so gas can be injected into the muffler 11 through the gas injection inlet 15. A gas exhaust outlet 16 is formed at an upper portion of the muffler 11, so gas can be exhausted to an exterior through the gas exhaust outlet 16.

However, the conventional heating apparatus 10 heats the optical fiber preform using one heater while moving the optical fiber preform up and down in the muffler 11. The current trend is towards a larger optical preform. That is, in the case of a porous optical fiber preform having a length of more than 1,500 mm and a diameter larger than 200 mm, a larger space must be formed in the muffler 11 for moving the porous optical fiber preform up and down in the muffler 11 and the length of the supporting rod must be lengthened to accommodate the size of the porous optical fiber, so that a muffler having a height of more than 3.5 m is required which in turn requires the height of equipment to increase to about 10 m.

If the height of equipment becomes high, manufacturing processes for an article may be complicated and the height of a factory also must become high, so maintenance cost is increased. In addition, because the volume of the muffler is enlarged, the amount of gas consumption may be increased.

In order to solve the above-mentioned problems, a heating apparatus 20 disclosed in U.S. Pat. No. 4,741,748 has been proposed, which is shown in FIG. 2. Referring to FIG. 2, an optical fiber preform 22 inputted into a muffler 21 is rotated in the muffler 21 without moving up and down. The heating apparatus 20 includes an induction heater 24 and a chamber 23 having a plurality of layers formed at an outer wall of the muffler 21. The induction heater 24 moves in a longitudinal direction at an exterior of the chamber 23.

However, since the above heating apparatus has a structure for heating the optical fiber preform while moving the induction heater 24 in the longitudinal direction at the exterior of the chamber, a device for moving the induction heater 24 is additionally required. As such, the number of parts of the heating apparatus may be increased, thus resulting in expensive manufacturing cost. Moreover, in order to prevent the muffler from being cooled and a carbon susceptor from being oxidized, the chamber has a complex structure including many layers forming a gas injection inlet, an auxiliary heater, and an insulation member, so excessive power is consumed.

### SUMMARY OF THE INVENTION

Accordingly, the present invention has been made to solve above-mentioned problems occurring in the prior art and provides additional advantages, by providing an apparatus for heating an optical fiber preform and a method for manufacturing the same. The invention improves the heat treatment process for products by uniformly performing a dehydration process with respect to the optical fiber preform using a plurality of heating sources stacked in the heating apparatus.

Another aspect of the present invention is to provide an apparatus for heating an optical fiber preform and a method for manufacturing the same, in which the optical fiber preform is vertically aligned and heated by means of a plurality of stacked heating sources, so that the length of a muffler provided in the heating apparatus can be shortened, thereby uniformly maintaining pressure in the muffler and reducing the amount of gas supplied into the muffler.

Still another aspect of the present invention is to provide an apparatus for heating an optical fiber preform and a method for manufacturing the same, in which the optical fiber preform is vertically aligned and heated by means of a plurality of stacked heating sources, so that the length of a support rod connected to the optical fiber preform can be shortened, thereby reducing the height of equipment.

In one embodiment, there is provided an apparatus for heating an optical fiber preform, the apparatus comprising: a muffler accommodating the optical fiber preform therein; and at least two heating sources aligned lengthwise along the optical fiber preform.

In another embodiment, there is provided a method for manufacturing a porous optical fiber preform which includes the steps of: forming soot consisting of glass particles and forming a soot preform by performing a primary heat-treatment process with respect to the soot preform; inputting the soot preform into a muffler provided at both sides thereof with at least two heating sources, which are aligned lengthwise along the soot preform; rotating the soot preform within the heating sources, injecting inert gas into the muffler, and performing a primary dehydration and dry process by increasing the temperature of each heating source; and, ejecting an optical fiber preform from the muffler after performing a secondary heat treatment process with respect to the soot preform by sequentially increasing the temperature of the heating sources according to a predetermined order.

### BRIEF DESCRIPTION OF THE DRAWINGS

The above features and advantages of the present invention will be more apparent from the following detailed description taken in conjunction with the accompanying drawings, in which:

FIG. 1 is a side view showing an operational state of a conventional heating apparatus for an optical fiber preform;

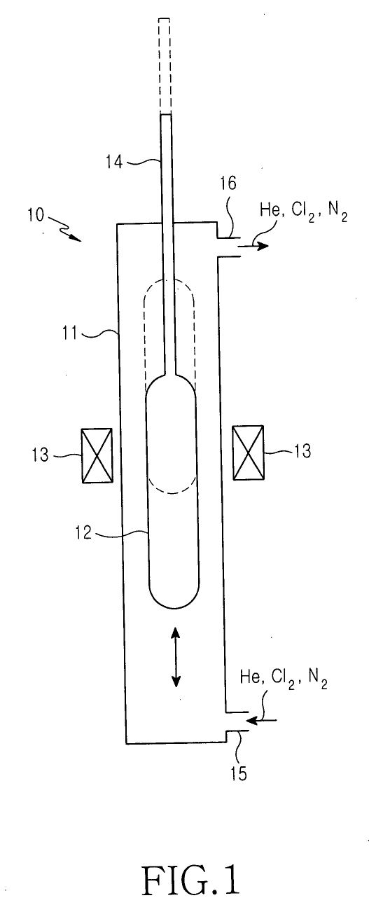

FIG. 2 is a side view showing an operational state of another conventional heating apparatus for an optical fiber preform;

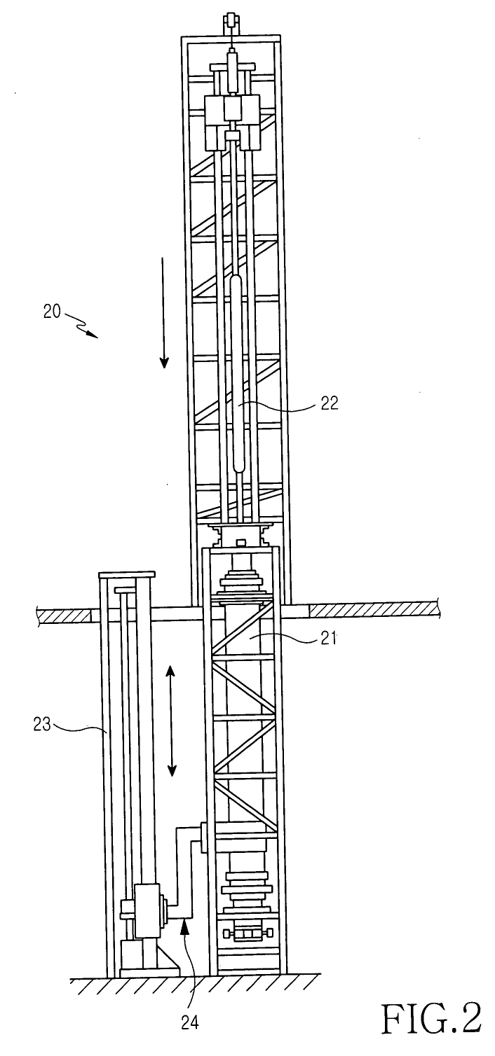

FIG. 3 is a side view showing an operational state of a heating apparatus for an optical fiber preform according to one embodiment of the present invention; and

FIG. 4 is a flowchart showing a method for manufacturing an optical fiber preform according to the present invention.

### DETAILED DESCRIPTION

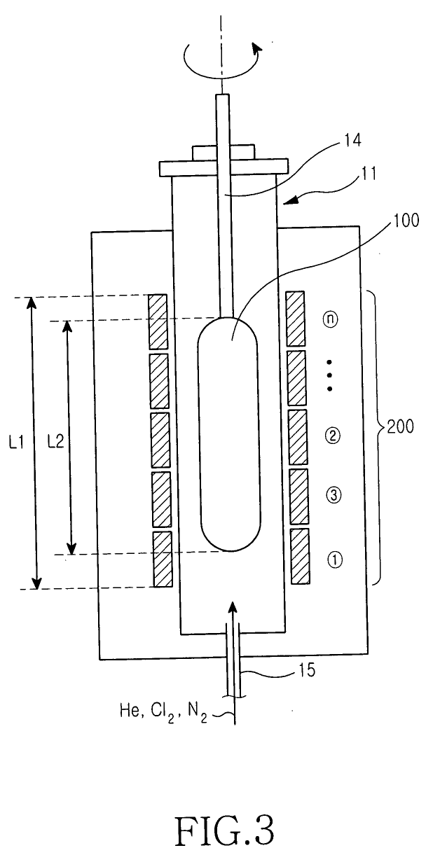

Referring to FIG. 3, a heating apparatus for manufacturing an optical fiber preform includes a muffler 11, and a gas injection inlet 15 formed at a lower portion of the muffler 11 to provide gas into the muffler 11. The optical fiber preform 100 is vertically disposed in the muffler 11. At least two heating sources 200 are vertically provided at both sides of the muffler 11 lengthwise along the optical fiber preform 100 in such a manner that the optical fiber preform 100 accommodated in the muffler 11 can be heat-treated according to a rotation of the optical fiber preform 100. In addition, the optical fiber preform 100 is a porous optical fiber preform, and is vertically and rotatably installed. The heating sources 200 are fixedly stacked in a vertical direction, thereby forming a furnace. The heating sources 200 forming the furnace can be rotated.

The temperature of the heating sources 200 gradually rises from a lower portion of the optical fiber preform 100 towards an upper portion of the optical fiber preform 100. The length L1 of the heating sources 200 is longer than the length L2 of the optical fiber preform 100. Also, the heating sources 200 can surround the optical fiber preform 100, and the heating sources 200 have a cylindrical shape. The optical fiber preform 100 can move up and down within a range of the heating sources 200 while the optical fiber preform 100 is being heated by the heating sources 200.

Hereinafter, an operation of the heating apparatus for the optical fiber preform according to an embodiment of the present invention will be described in detail with reference to FIG. 3.

Referring to FIG. 3, after forming soot consisting of glass particles, the soot is inputted into a furnace shown in FIG. 3. Then, a primary heat-treatment process is carried out in order to dehydrate the soot.

At this time, the soot is glassified through a secondary heat treatment process, thereby forming an optical fiber preform 100.

Herein, a soot preform is formed by depositing glass particles, and, if the soot preform has been processed through the heat treatment processes, it is referred to as an “optical fiber perform.”

Now, primary and secondary heat treatment processes for the optical fiber preform 100 will be explained.

Firstly, the optical fiber preform 100 is inputted into the muffler 11 provided at both sides thereof with at least two heating sources 200, which are vertically stacked in a lengthwise direction along the optical fiber preform 100. Herein, the length of the whole heating sources 200 is longer than the length of the optical fiber preform 100. Then, the optical fiber preform 100 is rotated, and He or Cl₂ gas is injected into the muffler 11 through the gas injection inlet 15. The temperature of the heating sources 200 is simultaneously increased, so that the primary dehydration and dry process is performed.

After performing the primary heat-treatment process, Cl₂ gas is removed. Herein, the temperature of the heating sources 200 is increased up to a range of about 1,000˜1,200° C.

In this state, the secondary heat treatment process is performed while sequentially increasing the temperature of the heating sources 200 from a first heating source located at the lowest portion of the optical fiber preform 100 towards an n^{th} heating source located at an uppermost portion of the optical fiber preform 100.

If the temperature of the heating sources 200 is increased, the optical fiber preform 100 slightly moves up and down within a range of the heating sources 200, so that the secondary heat treatment process is carried out for the optical fiber preform 100.

After the second heat treatment process has been carried out, N₂ gas is injected into the muffler 11 instead of He gas, so that the optical fiber preform 100 is completed.

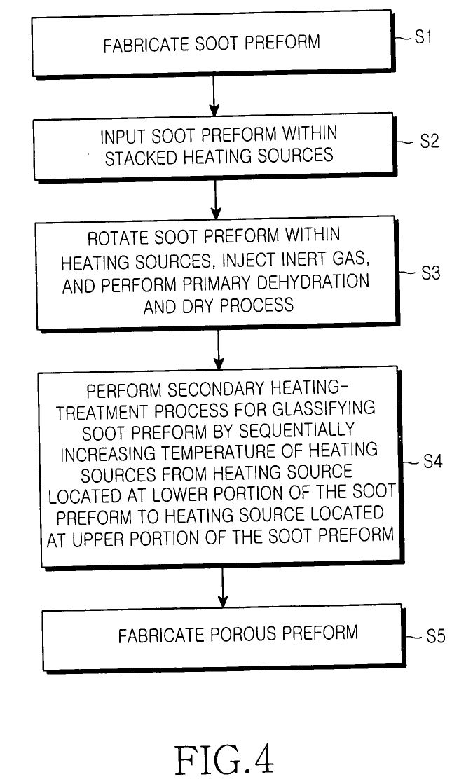

Referring to FIG. 4, an operation of a manufacturing method for the optical fiber preform having the above-mentioned construction according to another embodiment of the present invention will be described in detail.

As shown in FIG. 4, the soot has a diameter of 170 mm and a length of 1,500 mm, and is glassified through a heat treatment process, so that the optical fiber preform 100 is formed (S1).

At this time, the heat treatment process is carried out at the temperature of 1,100° C.

Herein, the optical fiber preform 100 is inputted into the muffler 11 provided at both sides thereof with at least two heating sources 200, which are vertically stacked lengthwise along the optical fiber preform 100 (S2).

At this time, an upper end and a lower end of the optical fiber preform 100 are located at the centers of heating sources 200 corresponding to the upper and lower ends of the optical fiber preform 100, respectively.

After step S2, the optical fiber preform 100 is rotated within the heating sources 200, and He gas of 12 slpm or Cl₂ gas of 0.3 slpm is injected into the muffler 11 through the gas injection inlet 15. Thus, the temperature of the heating sources 200 is simultaneously increased, so that the primary dehydration and dry process is performed (S3).

Herein, the primary dehydration and dry process is carried out at the temperature of 1,100° C.

Then, after performing the primary heat treatment process, Cl₂ gas is removed from the muffler 11, and a purging process is carried out for 30 minutes.

After step S3, the temperature of the heating sources 200 is increased to 1,520° C. by a velocity of 30° C./minute from the first heating source 200 located at a position corresponding to the lower end of the optical fiber preform 100 to the n^{th} heating source located corresponding to the upper end of the optical fiber preform 100.

At this time, when the temperature of the heating sources 200 reaches the temperature of 1520° C., the optical fiber preform 100 is moved down with a velocity of 5.5 mm/min (a moving distance 250 mm) so that the heat treatment process is carried out with respect to the optical fiber preform 100.

After the optical fiber preform 100 is moved down by a distance of 250 mm, if the temperature of the heating sources 200 decreases, the optical fiber preform 100 again returns to its initial position.

As described above, the temperature of a second heating source located on an upper portion of the first heating source and the n^{th} heating source, located at a position corresponding to the upper end of the optical fiber preform, may sequentially rise, thereby performing the secondary heat treatment process for the optical fiber preform 100. After that, N₂ gas of 5 slpm is injected into the muffler 11 after stopping the supply of He gas into the muffler 11 (S4).

After step S4, the optical fiber preform 100 passing through the secondary heat treatment process is separated from the supporting rod 14 (S5).

Although a preferred embodiment of the present invention has been described for illustrative purposes, those skilled in the art will appreciate that various modifications, additions and substitutions are possible, without departing from the scope and spirit of the invention as disclosed in the accompanying claims.

1. An apparatus for heating an optical fiber preform, comprising:
a muffler for housing the optical fiber preform therein; and
at least two heating sources aligned in a lengthwise direction a long the optical fiber preform.

2. The apparatus as claimed in claim 1, further comprising a gas injection inlet formed at a lower portion of the muffler to provide gas into the muffler.

3. The apparatus as claimed in claim 1, wherein the heat sources apply a heat treatment according to a rotation of the optical fiber preform.

4. The apparatus as claimed in claim 1, wherein the optical fiber preform includes a porous optical fiber preform.

5. The apparatus as claimed in claim 1, wherein the optical fiber perform is rotatably disposed in the muffler in a substantially vertical orientation.

6. The apparatus as claimed in claim 1, wherein the heating sources are fixedly stacked in a vertical direction, forming a furnace.

7. The apparatus as claimed in claim 1, wherein the heating sources are rotatable around the muffler.

8. The apparatus as claimed in claim 1, wherein the temperature of the heating sources is sequentially increased according to a predetermined order.

9. The apparatus as claimed in claim 1, wherein the temperature of the heating sources is gradually increased from a lower portion of the optical fiber preform towards an upper portion of the optical fiber preform.

10. The apparatus as claimed in claim 1, wherein the heating sources have a length longer than a length of the optical fiber preform.

11. The apparatus as claimed in claim 1, wherein the heating sources surround the optical fiber preform.

12. The apparatus as claimed in claim 1, wherein the heating sources have a cylindrical shape.

13. The apparatus as claimed in claim 1, wherein the optical fiber preform moves up and down within a range of the heating sources while a heat treatment process for the optical fiber preform is performed.

14. A method for manufacturing a porous optical fiber preform, the method comprising the steps of:
i) forming soot consisting of glass particles and forming a soot preform by applying a primary heat-treatment thereto;
ii) inputting the soot preform into a muffler provided at both sides thereof with at least two heating sources aligned in a lengthwise direction along the soot preform;
iii) rotating the soot preform within the heating sources, injecting inert gas into the muffler, and performing a primary dehydration and a dry process by increasing temperature of each heating source; and
iv) removing an optical fiber preform formed from the soot perform after applying a secondary heat treatment with respect to the soot preform by sequentially increasing the temperature of the heating sources according to a predetermined order.

15. The method as claimed in claim 14, wherein, in step i), the temperature of the heating sources is increased simultaneously.

16. The method as claimed in claim 14, wherein the temperature of the heating sources is sequentially increased from a first heating source located at a lower portion of the soot preform to an n^{th} heating source located at an upper portion of the soot preform when performing the second heat treatment.

17. The method as claimed in claim 14, wherein, when performing the second heat treatment, the soot preform is moved up and down from a first heating source to an n^{th} heating source or vice versa.

18. A method for manufacturing a porous optical fiber preform, the method comprising the steps of:
i) forming a soot consisting of glass particles and forming a soot preform by performing a primary heat-treatment with respect to the soot preform;
ii) inputting the soot preform into a muffler provided at both sides thereof with at least two heating sources aligned lengthwise direction along the soot preform;
iii) rotating the heating sources around the soot preform, injecting inert gas into the muffler, and performing a primary dehydration and a dry process by increasing a temperature of each heating source; and
iv) removing an optical fiber preform formed from the sooth perform after performing a secondary heat treatment with respect to the soot preform by sequentially increasing temperature of the heating sources according to a predetermined order.
